(19) United States
(12) Patent Application Publication
(10) Pub. No.: US 2014/0250599 A1
(43) Pub. Date: Sep. 11, 2014

(54) Deck Assembly For Adjustable Bed

(71) Applicant: L&P PROPERTY MANAGEMENT COMPANY, South Gate, CA (US)

(72) Inventors: Samantha L. Cassell, Chetopa, KS (US); William R. Rohr, Joplin, MO (US)

(73) Assignee: L&P PROPERTY MANAGEMENT COMPANY, South Gate, CA (US)

(21) Appl. No.: 13/792,998

(22) Filed: Mar. 11, 2013

(51) Int. Cl. A61G 7/015

(52) U.S. Cl. CPC A61G 7/015
USPC 5/613

(57) ABSTRACT

An adjustable bed base includes a deck assembly made at least partially of foam. In one embodiment multiple sections of the deck assembly are joined to each other with living hinges formed from a plastic material coating the different sections of deck. In another embodiment, each section is made from foam surrounded with a plastic cover and adjacent sections joined with conventional hinges.

### TECHNICAL FIELD

The present invention relates generally to adjustable beds and, more particularly, to an adjustable bed base having a deck assembly partially made of foam.

### BACKGROUND

A well known type of bedding product comprises a motorized adjustable bed in which an articulated deck supports a mattress. Such motorized adjustable beds have traditionally been used in hospitals, but more and more are being installed in residential homes. Motorized adjustable beds have conventionally had an upper body support movable between an inclined position in which the body support supports a person in a sitting position and a prone position in which the person lies down in a generally horizontal position. In addition, a leg support is movable between positions and may be adjusted to a desired degree of inclination. An actuating mechanism, commonly two or more electric motors, raises and lowers the head and leg supports of the articulated deck. U.S. Pat. No. 7,900,302 discloses such an adjustable bed. One drawback to existing adjustable bed bases is that they are relatively heavy to move. One element which contributes to the weight of the adjustable bed base may be an articulated deck which may be made of several pieces of wood hinged together. Over time, the hinges may fail to function properly.

Thus, a need exists in the art for a deck assembly for use with an adjustable bed base which may reduce the weight of the adjustable bed base.

There is further a need in the art for a deck for an adjustable bed base which does not require separate hinges to secure portions of the deck together.

### SUMMARY OF THE INVENTION

According to one embodiment of the invention, a deck assembly for an adjustable bed is provided. The deck assembly comprises multiple pieces of foam and a plastic coating surrounding each of the pieces of foam. The plastic coating may extend between adjacent pieces of foam in the form of living hinges.

According to another aspect of the invention, an adjustable bed base comprises a stationary base and a frame movable relative to the stationary base. The adjustable bed base further comprises a deck assembly secured to the movable frame. The deck assembly comprises a seat deck section secured to the movable frame, a head deck section connected to the seat deck section with a living hinge, a leg deck section secured to the seat deck section with a living hinge and a leg deck section secured to the leg deck section with a living hinge.

According to another aspect of the invention, an adjustable bed base comprises a frame movable relative to a stationary base and a deck assembly secured to the movable frame. The deck assembly comprises multiple sections secured together, at least one of the sections comprising a foam interior and a plastic coating surrounding the foam interior. According to one embodiment, each of the sections comprises a piece of foam surrounded with a plastic coating.

In any of the embodiments, reinforcements in the form of wooden or plastic blocks may be located inside any of the sections of the foam deck assembly. Such reinforcements may be used as anchors into which fasteners, such as screws, may be secured. Additionally, the reinforcements may be used for stability and/or strength in one or more of the deck sections.

At least in part due to the materials of the deck assembly, any of the embodiments of the deck assembly of the present invention may reduce the weight of the adjustable bed base relative to heretofore known deck assemblies which are typically made of solid pieces of wood or plastic. Any weight reduction in the adjustable bed base may be desirable in order to make movement and construction or assembly of the adjustable bed base easier and/or less costly.

### BRIEF DESCRIPTION OF THE DRAWINGS

The accompanying drawings, which are incorporated in and constitute a part of this specification, illustrate embodiments of the invention and, together with the general description given above and the detailed description of the embodiments given below, serve to explain the principles of the invention. In the figures, corresponding or like numbers or characters indicate corresponding or like structures.

FIG. 1 is a bottom perspective view of an adjustable bed made in accordance with this invention supporting a mattress shown in phantom.

FIG. 2 is a bottom perspective view of the adjustable bed base used in the adjustable bed of FIG. 1 without the mattress.

FIG. 3 is a perspective view of the deck assembly used in the adjustable bed base of FIG. 1.

FIG. 4 is cross-sectional view taken along line 4-4 of FIG. 3.

FIG. 4A is a cross-sectional view of an alternative deck assembly.

FIG. 5 is a side elevational view of the adjustable bed base of FIG. 1 in a horizontal position.

FIG. 6 is a side elevational view of the adjustable bed base of FIG. 1 in a fully inclined position.

FIG. 7 is a perspective view of an alternative deck assembly which may be used in any adjustable bed base.

FIG. 8 is cross-sectional view taken along line 8-8 of FIG. 7.

### DETAILED DESCRIPTION OF THE ILLUSTRATIVE EMBODIMENTS

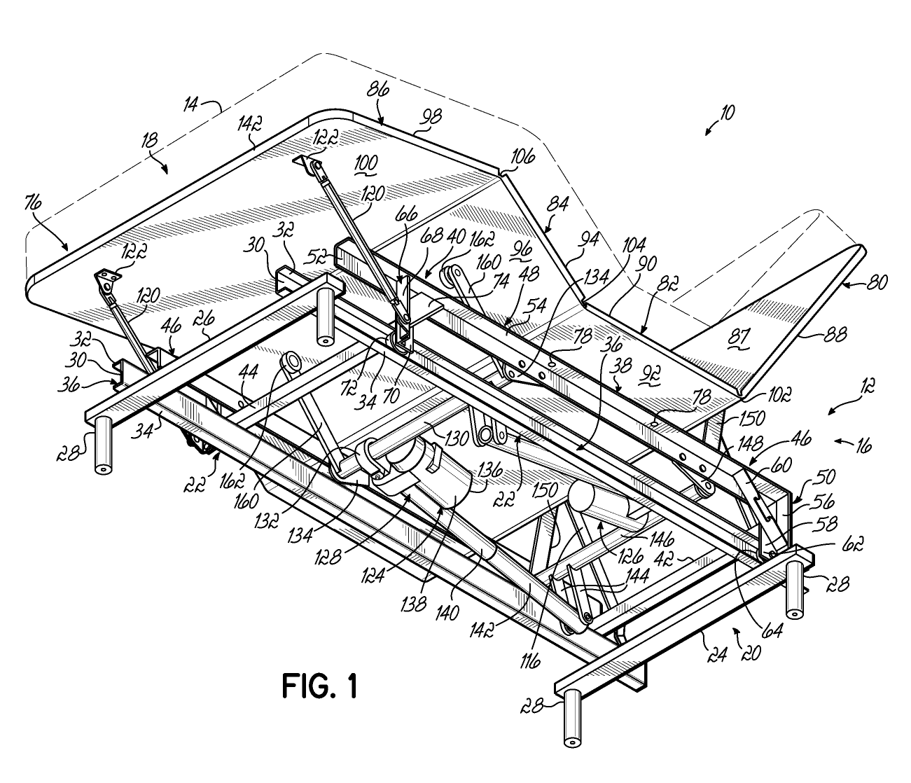

Referring to the drawings and, particularly FIG. 1, there is illustrated an adjustable bed 10, including an adjustable bed base 12 supporting a mattress 14. The adjustable bed base 12 may be used to support any type of mattress 14, including an air mattress, a foam mattress, a spring mattress or any other type of mattress. The mattress 14 does not form a part of the present invention.

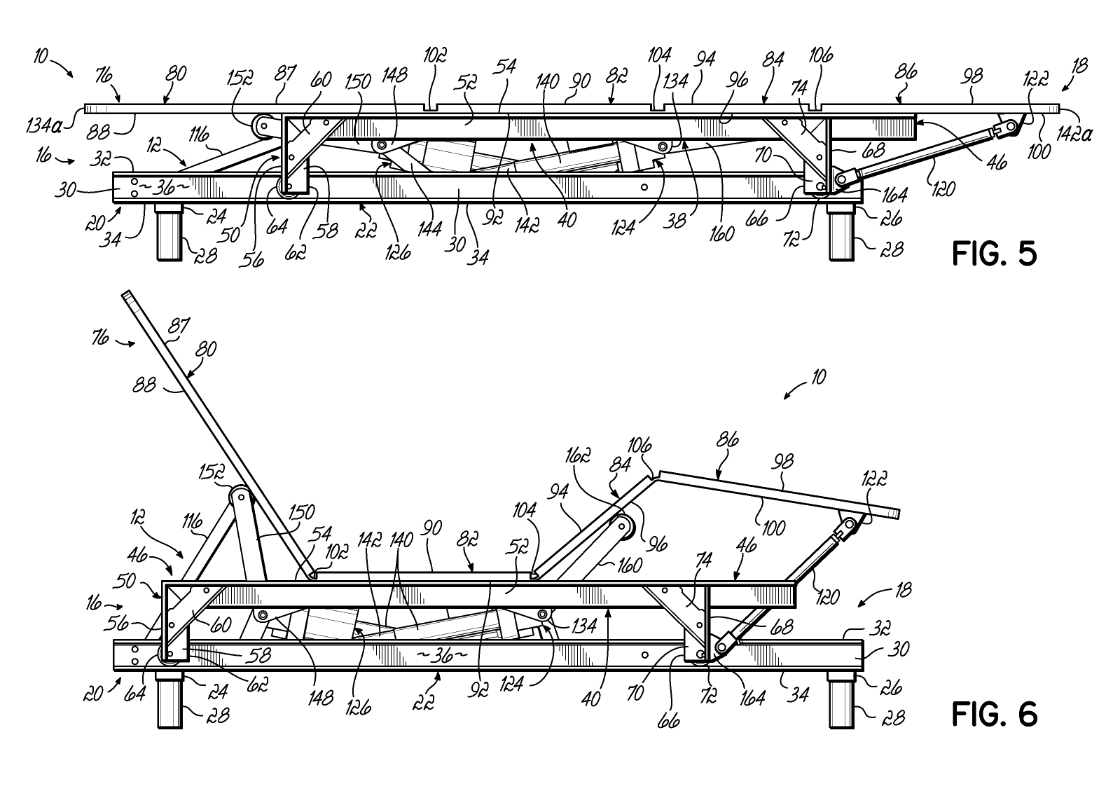

Referring to FIG. 1, the adjustable bed base 12 has a head end 16 and a foot end 18. The adjustable bed base 12 is movable between a first horizontal position shown in FIG. 5 and a fully inclined position shown in FIGS. 1, 2 and 6. Typically, an operator or user sleeps with the adjustable bed base 12 in its first horizontal position and reads or watches television with the adjustable bed base 12 in its fully inclined position. However, the adjustable bed base 12 may assume any intermediate position between the extreme positions illustrated and may be maintained in such a position.

The adjustable bed base 12 comprises a stationary generally rectangular base 20 comprising a pair of opposed side rails 22, a head end rail 24, a foot end rail 26 and four legs 28 supporting the base 20 a fixed distance above a floor or supporting surface (not shown). The head and foot end rails 24, 26, respectively, each are secured to each side rail 22 and extend therebetween. The head and foot end rails 24, 26, respectively, are illustrated as being rectangular in cross-section. However, they may be any desired size or shape, hollow or solid. The legs 28 are shown secured and extending downwardly from the head and foot end rails 24, 26, respectively, but may be secured to the side rails 22, if desired. Although a cylindrical-shaped leg 22 is illustrated, any configuration or length of leg or similar support may be used.

As shown in FIGS. 1, 5 and 6, each of the side rails 22 of the base 20 has a generally C-shaped cross-sectional configuration, including a vertically oriented side portion 30, a horizontally oriented top portion 32 extending outwardly from the upper edge of the side portion 30, and a horizontally oriented bottom portion 34 extending outwardly from the lower edge of the side portion 30. The side, top and bottom portions, 30, 32 and 34, respectively, define an outwardly facing channel 36 in each side rail 22 of the base 20. Although each side rail 22 is illustrated having a generally C-shaped cross-sectional configuration along its entire length, any desired configuration or length of side rail may be used in the base. For example, the channels may be shaped differently than those illustrated.

The adjustable bed base 12 further comprises a frame 38 movable relative to the stationary base 20. The frame 38 is movable between a first position shown in FIG. 5 when the adjustable bed base 12 is in its first horizontal position and a second position shown in FIGS. 1 and 6 when the adjustable bed base 12 is in its second fully inclined position as shown in FIGS. 1 and 6. In its first position shown in FIG. 5, the frame 38 is located proximate the foot end 18 of the bed (to the right as shown in FIG. 5). In its second position shown in FIGS. 1 and 6, the frame 38 is located proximate the head end 16 of the bed (to the left as shown in FIGS. 1 and 6).

As shown in the drawings, the movable frame 38 comprises a pair of side assemblies 40 connected by front and rear cross members 42, 44, respectively. Each of the front and rear cross members 42, 44, respectively, is joined to each side assembly 40 and extends therebetween. The front and rear cross members 42, 44, respectively, of the movable frame 38 are illustrated as being rectangular in cross-section. However, they may be any desired size or shape, hollow or solid.

Each of the side assemblies 40 of the movable frame 38 comprises a generally “L-shaped” member 46 having a horizontal portion 48 and a vertical leg portion 50 at the head end 16 of the adjustable bed base 12 extending downwardly from the horizontal portion 48 of the generally “L-shaped” member 46. The horizontal portion 48 has a vertical flange 52 and a horizontal flange 54. While the vertical leg portion 50 has a first flange 56, a continuation of the horizontal flange 54 and a second flange 58, a continuation of the vertical flange 52. Thus, each portion 48, 50 of each generally “L-shaped” member 46 has an “L-shaped” configuration.

A front brace 60 extends between the horizontal portion 48 and the vertical leg portion 50 of the generally “L-shaped” member 46. The front brace 60 is riveted, welded or otherwise secured to the vertical flange 52 of the horizontal portion 48 and the second flange 58 of the leg portion 50 of the generally “L-shaped” member 46. Although one configuration of front brace 60 is illustrated, other configurations or styles of braces may be used.

For purposes of this document, the vertical leg portion 50 of each generally “L-shaped” member 46 of the movable frame 38 may be referred to as a head or front leg 62 which has a front roller 64 rotatably secured at the bottom thereof, each front roller 64 being sized and adapted to travel inside the channel 36 of one of the side rails 22 of the stationary base 20. The front roller 64 is rotatably secured to the second flange 58 of the front leg 62.

Each of the side assemblies 40 further comprises a support or rear leg 66 having a first flange 68 and a second flange 70 at right angles or orthogonal to each other. Thus, the support or rear leg 66 has a cross sectional configuration which is generally “L-shaped”. The first flange 68 of the rear leg 66 is parallel the first flange 56 of the front leg 62, while the second flange 70 of the rear leg 66 is parallel the second flange 58 of the front leg 62. A rear roller 72 is rotatably secured to the second flange 70 of the rear leg 66 of each side assembly 40 of the movable frame 38. Each rear roller 72 is sized and adapted to travel inside the channel 36 of one of the side rails 22 of the stationary base 20.

A rear brace 74 extends between the horizontal portion 48 of the generally “L-shaped” member 46 and the rear leg 66 of each side assembly 40 of the movable frame 38. The rear brace 74 is welded, riveted or otherwise secured to the vertical flange 52 of the horizontal portion 48 of the generally “L-shaped” member 46 and the second flange 70 of the rear leg 66 of each side assembly 40 of the movable frame 38. Although one configuration of rear brace 74 is illustrated, other braces may be used.

A deck assembly 76 is operatively coupled to the movable frame 38 with multiple fasteners 78, as shown in FIG. 1. More particularly, the deck assembly 76 is secured to the horizontal portions 48 of each of the generally “L-shaped” members 46 of the movable frame 38. The deck assembly 76 comprises a head deck section 80, a seat deck section 82, a leg deck section 84 and a foot deck section 86. As shown in FIG. 1, only the seat deck section 82 of the section is secured to the horizontal portions 48 of each of the generally “L-shaped” members 46 of the movable frame 38.

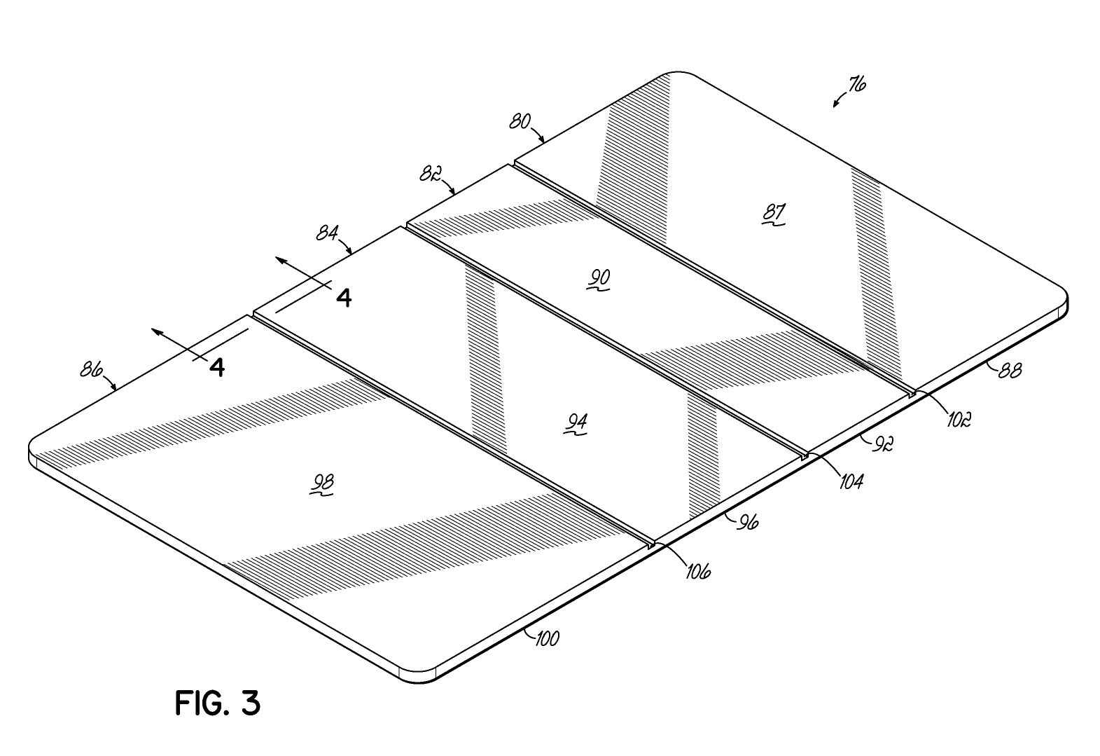

As shown in FIG. 1, the head deck section 80 has upper and lower surfaces 87, 88, respectively. Similarly, as shown in FIG. 3, the seat deck section 82 has upper and lower surfaces 90, 92, respectively. Similarly, the leg deck section 84 has upper and lower surfaces 94, 96, respectively. Lastly, as shown in FIG. 3, the foot deck section 86 has upper and lower surfaces 98, 100, respectively.

As shown in FIGS. 1, 2 and 3, the head deck section 80 is hingedly secured to the seat deck section 82 via a living hinge 102 and movable relative to the seat deck section 82, which is fixed to the movable frame 38. Similarly, the seat deck section 82 is hingedly secured to the leg deck section 84 via a living hinge 104 and movable relative to the leg deck section 84. Lastly, the leg deck section 84 is hingedly secured to the foot deck section 86 via a living hinge 106 and movable relative to the leg deck section 84.

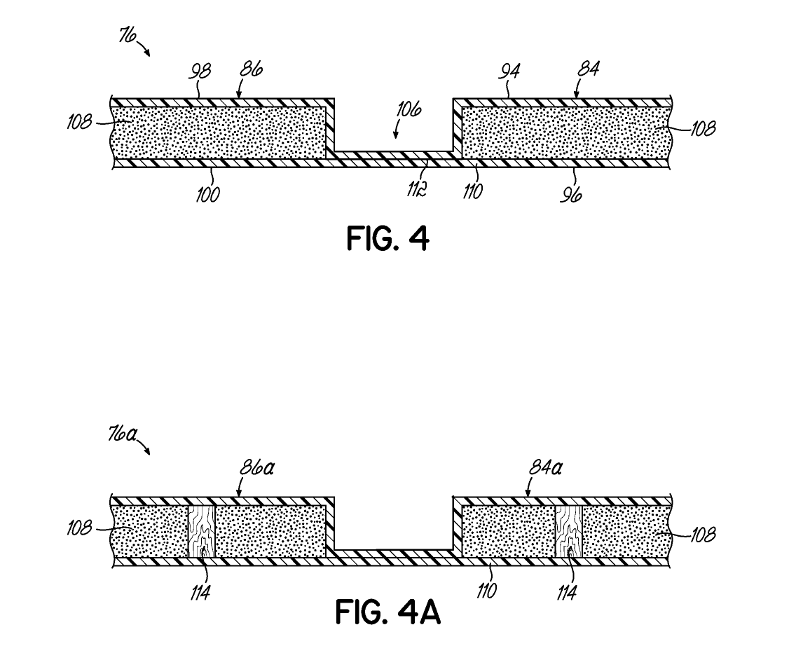

As best shown in FIG. 4, each of the sections 80, 82, 84 and 86 of the deck assembly 76 may comprise a foam interior or piece 108 surrounded by a plastic coating or sheath 110. At each of the living hinges, the plastic coating or sheath 110 may be secured to itself, as best shown in FIG. 4 along seam 112. Each of the foam pieces 108 may be made of polystyrene, which may be blow molded or formed in any known manner. The plastic coating 110 may be made of polyethylene, polypropylene or any known polymer or plastic material.

FIG. 4A illustrates a portion of an alternative embodiment of deck assembly 76a in which one or more of the sections of the deck assembly 76a may include one or more reinforcers 114 inside the foam interior 108 and being surrounded by a plastic coating or sheath 110. Although FIG. 4A illustrates two reinforcers 114, one extending transversely inside leg deck section 84a and another extending transversely inside foot deck section 86a, any number of reinforcers may be used in any of the deck sections for structural integrity and strength. Such reinforcers may be made of metal, wood or plastic and may be any desired size or shape. If desired, wooden reinforcers may be located where the fasteners 78 secure the seat section 82 of deck assembly 76 to the frame 38 of the adjustable bed base 12. This may be true in any of the embodiments described herein.

As illustrated in FIG. 1, the seat deck section 82 is fixedly secured to the movable frame 32 with fasteners 78. More particularly, the fasteners 78 pass through holes in the horizontal flange 54 of the horizontal portion 48 of each side assembly 40 of the movable frame 38 and into the material of the seat deck section 82. Thus, the seat deck section 82 remains flat and fixed in the same location relative to the movable frame 38. When the movable frame 38 moves, the seat deck section 82 moves with it.

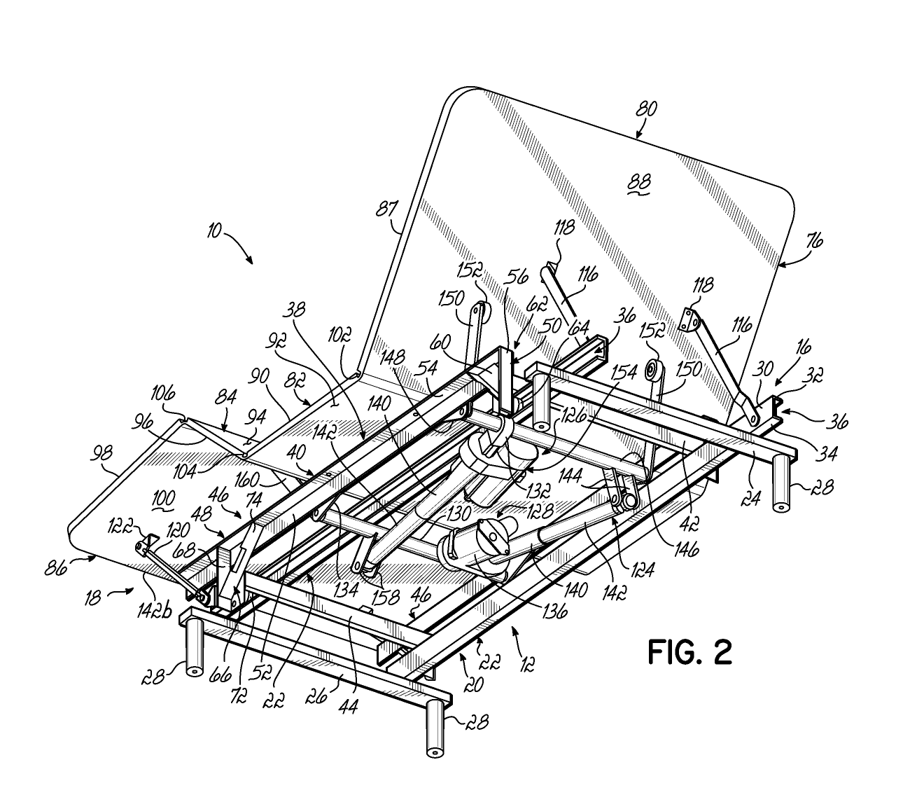

The adjustable bed base 12 further comprises connectors in the form of links of fixed lengths which limit the travel of the movable frame 38 relative to the stationary base 20 and limit the movement of the deck assembly 76. As best shown in FIG. 2, the adjustable bed base 12 has two head links 116, each of the same fixed length and each pivotally secured at its lower end to one of the side rails 22 of the stationary base 20 with a fastener so that each pivots about a horizontal pivot axis. See FIG. 2. At its upper end, each of the head links 116 is pivotally secured to a bracket 118 fixedly secured to the lower surface 100 of the head deck section 80. The upper end of each head link 116 also pivots about a horizontal axis. Each of the brackets 118 may be secured to reinforcers (not shown) located in the head section 80 of deck assembly 76.

As illustrated in FIGS. 1, 2, 5 and 6, two foot links or connectors 120, each of the same fixed length, are each pivotally secured at a lower end to a bracket 164 secured to one of the rear legs 66 of one of the side assemblies 40 of the movable frame 38 with a fastener so that each pivots about a horizontal pivot axis. Each foot link 120 is pivotally secured at its upper end to a bracket 122 fixed to a lower surface 100 of the foot deck section 86. Each of the brackets 118 may be secured to reinforcers (not shown) located in the head section 80 of deck assembly 76.

The deck assembly 76 is moved by two motorized linear actuator assemblies 124, 126 which are part of the movable frame 38 and move with the movable frame 38 relative to the stationary base 20. The first motorized linear actuator assembly 124 comprises a first motorized linear actuator 128 secured to a first rotatable or pivotal torque tube 130 of the movable frame 38 by a connector 132. The first torque tube 130 forms part of the movable frame 38 and is secured to and extends between two brackets 134. Each bracket 134 is secured to a vertical flange 52 of the horizontal portion 48 of one of the generally “L-shaped” members 46 of one of the side assemblies 40 of the movable frame 38. The first motorized linear actuator assembly 124 further comprises an AC motor 136 inside a housing 138, a housing tube 140 and an extension tube 142 extendable from inside the housing tube 140 and secured to a pin extending between a pair of link arms 144 in a manner described in U.S. Pat. Nos. 7,900,302 and 7,530,125, which are fully incorporated herein. Each of the link arms 144 is welded or otherwise secured to a second rotatable or pivotal torque tube 146 of the movable frame 38. The second torque tube 146 is mounted between brackets 148, each bracket 148 being secured to a vertical flange 52 of the horizontal portion 48 of one of the generally “L-shaped” members 46 of one of the side assemblies 40 of the movable frame 38. Thus, the second torque tube 146 is part of the first motorized linear actuator assembly 124 and moves with the movable frame 38. As best shown in FIG. 2, the second torque tube 146 has a pair of spaced operating arms 150 extending upwardly therefrom, each arm 150 being a fixed length and having a roller 152 at the end thereof for engaging the lower surface 88 of the head deck section 80. Each operating arm 150 is welded or otherwise secured to the second torque tube 146 at its lower end.

The second motorized linear actuator assembly 126 comprises a second motorized linear actuator 154 secured to the second torque tube 146 of the movable frame 38 by a connector 132. The second torque tube 146, like the first torque tube 130, forms part of the movable frame 38. The second motorized linear actuator assembly 126 further comprises an AC motor 136 inside a housing 138, a housing tube 140 and an extension tube 142 extendable from inside the housing tube 140 and secured to a pin extending between a pair of link arms 158 in a manner described in U.S. Pat. Nos. 7,900,302 and 7,530,125. Each of the link arms 158 is welded or otherwise secured to the first torque tube 130 of the movable frame 38. The first torque tube 130 has a pair of spaced operating arms 160 extending upwardly therefrom, each arm 160 being a fixed length and having a roller 162 at the end thereof for engaging the lower surface 100 of the foot deck section 86. Each operating arm 160 is welded or otherwise secured to the first torque tube 130 at its lower end.

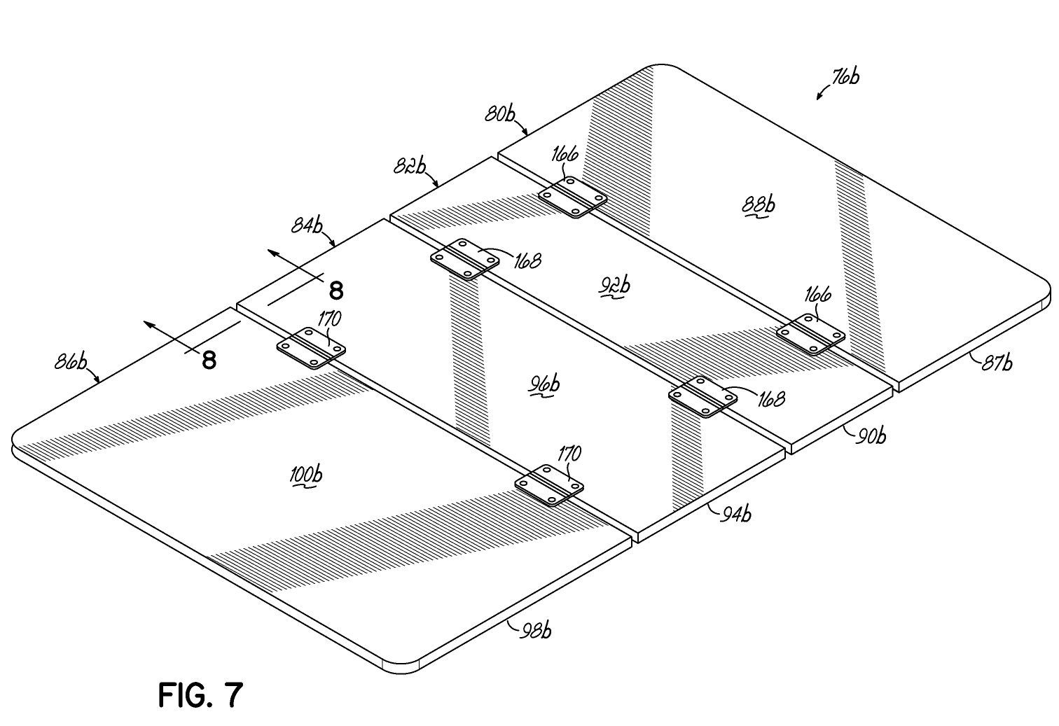

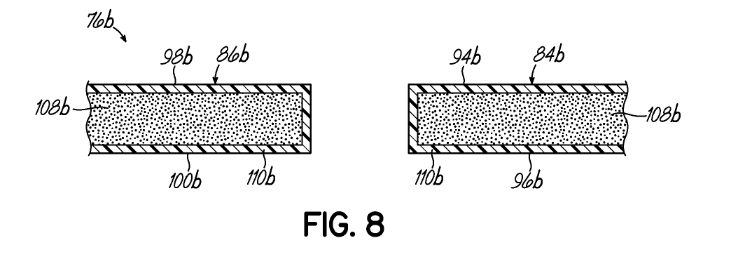

FIGS. 7 and 8 illustrate an alternative embodiment of deck assembly 76b comprising a head deck section 80b, a seat deck section 82b, a leg deck section 84b and a foot deck section 86b. The head deck section 80b has upper and lower surfaces 87b, 88b, respectively. As shown in FIG. 7, the seat deck section 82b has upper and lower surfaces 90b, 92b, respectively. Similarly, the leg deck section 84b has upper and lower surfaces 94b, 96b, respectively. Lastly, the foot deck section 86b has upper and lower surfaces 98b, 100b, respectively.

As shown in FIG. 7, the head deck section 80b is hingedly secured to the seat deck section 82b via two spaced hinges 166 and movable relative to the seat deck section 82b, which may be fixed or secured to the movable frame 38. Similarly, the seat deck section 82b is hingedly secured to the leg deck section 84b via two spaced hinges 168 and movable relative to the leg deck section 84b. Lastly, the leg deck section 84b is hingedly secured to the foot deck section 86b via two spaced hinges 170 and movable relative to the foot deck section 86b.

As shown in FIG. 8, each of the deck sections 80b, 82b, 84b and 86b of the deck assembly 76b may comprise a foam interior or piece 108b surrounded by a plastic coating or sheath 110b. Each of the foam pieces 108b may be made of polystyrene, which may be blow molded or formed in any known manner. The plastic coating 110b may be made of polyethylene, polypropylene or any known polymer or plastic material.

While the invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. Therefore, the invention in its broadest aspects is not limited to the specific details shown and described. The various features disclosed herein may be used in any combination necessary or desired for a particular application. Consequently, departures may be made from the details described herein without departing from the spirit and scope of the claims which follow.

What is claimed is:

1. A deck assembly for a motorized adjustable bed base, the deck assembly comprising:
multiple pieces of foam;
a plastic coating surrounding each of the pieces of foam, wherein the plastic coating extends between adjacent pieces of foam.

2. The deck assembly of claim 1, wherein each of the pieces of foam is rectangular.

3. The deck assembly of claim 1, wherein at least one of the pieces of foam is made of polystyrene.

4. The deck assembly of claim 1, wherein the plastic coating comprises polyethylene.

5. The deck assembly of claim 1, wherein the foam is blow molded.

6. The deck assembly of claim 1, wherein living hinges are located between adjacent pieces of foam.

7. The deck assembly of claim 1, wherein at least one of the pieces of foam has openings therethrough for fasteners.

8. A motorized adjustable bed base comprising:
a stationary base;
a frame movable relative to the stationary base via activation of at least one electric motor;
a deck assembly secured to the movable frame, the deck assembly comprising a seat deck section secured to the movable frame, a head deck section connected to the seat deck section with a living hinge, a leg deck section secured to the seat deck section with a living hinge and a leg deck section secured to the leg deck section with a living hinge.

9. The adjustable bed base of claim 8, wherein at least one of the sections of the deck assembly has a foam interior and a plastic cover.

10. The adjustable bed base of claim 8, wherein each of the sections of the deck assembly has a foam interior and a plastic cover.

11. The adjustable bed base of claim 8, further comprising two actuators secured to the movable frame.

12. The adjustable bed base of claim 9, wherein the foam is polystryrene.

13. The adjustable bed base of claim 10, wherein the foam is polystryrene.

14. The adjustable bed base of claim 8, wherein each of the sections of the deck assembly are covered with a plastic coating.

15. The adjustable bed base of claim 8, wherein at least one of the sections of the deck assembly has a blow molded foam interior.

16. The adjustable bed base of claim 8, wherein each of the sections of the deck assembly has a blow molded foam interior.

17. An adjustable bed base comprising:
a frame movable relative to a stationary base via activation of at least one electric motor;
a deck assembly secured to the movable frame, the deck assembly comprising a multiple section secured together, at least one of the sections comprising a foam interior and a plastic coating surrounding the foam interior.

18. The adjustable bed base of claim 17, wherein at least one of the sections of the deck assembly has a blow molded foam interior.

19. The adjustable bed base of claim 17, wherein the sections of the deck assembly are connected with living hinges.

20. The adjustable bed base of claim 17, wherein the foam is polystryrene.
